(19) United States
(12) Patent Application Publication
(10) Pub. No.: US 2026/0021543 A1
(43) Pub. Date: Jan. 22, 2026

(54) VAPOR CHAMBER MANUFACTURING PROCESS AND PRODUCT THEREOF

(71) Applicants: Chin-Wen WANG, Taoyuan City (TW); Pei-Choa WANG, Taoyuan City (TW); Ching-Chung WANG, Taoyuan City (TW)

(72) Inventor: Chin-Wen WANG, Taoyuan City (TW)

(21) Appl. No.: 19/265,344

(22) Filed: Jul. 10, 2025

(30) Foreign Application Priority Data
Jul. 19, 2024 (TW) 113127084

(51) Int. Cl. B23P 15/26; F28D 15/04

(52) U.S. Cl. CPC B23P 15/26; F28D 15/04; B23P 2700/09

(57) ABSTRACT

This disclosure provides a vapor chamber manufacturing process, which includes the steps of: a) providing a stainless steel shell having a cavity; b) roughening an inner wall surface of the stainless steel shell to form a roughened surface; c) forming a capillary structure on the roughened surface; d) forming a supporting structure by selective laser sintering 3D printing and positioning the supporting structure in the cavity; e) filling a working fluid; f) providing a sealed chamber and placing the stainless steel shell therein; g) evacuating the sealed chamber; and h) sealing the stainless steel shell. Furthermore, this disclosure also provides a vapor chamber manufactured using the aforementioned vapor chamber manufacturing process to achieve the objectives of reducing manufacturing complexity and cost, avoiding the need for additional space, and facilitating a thinner vapor chamber design.

### BACKGROUND OF THE DISCLOSURE

### Technical Field

The technical field relates to a vapor chamber, and more particularly to a vapor chamber manufacturing process without a degassing tube and a product thereof.

### Description of Related Art

In the manufacturing processes of vapor chambers of the related art, a vent/filling tube (also referred to as a degassing tube) is typically required for filling a working fluid and performing degassing or vacuuming. Then, edge welding and sealing processes are performed to complete the vapor chamber. However, the disposition of the vent/filling tube not only increases manufacturing complexity and cost but also may take up extra space, which is not conducive to the thin design of vapor chambers.

Furthermore, vapor chambers are generally equipped with internal supporting structures to provide sufficient mechanical support to the internal space, thereby preventing deformation or damage during manufacturing or use. Additionally, a well-designed internal supporting structure helps distribute heat evenly, avoiding localized overheating and thereby enhancing the thermal performance of the vapor chamber. However, the design and fabrication of such supporting structures require precise manufacturing techniques, which increase manufacturing complexity and cost.

In view of the above drawbacks, the inventor proposes this disclosure based on his expert knowledge and elaborate researches in order to solve the problems of related art.

### SUMMARY OF THE DISCLOSURE

One objective of this disclosure is to provide a vapor chamber manufacturing process and product thereof, which is constructed without a vent/filling tube, thereby reducing manufacturing complexity and cost, avoiding the need for additional space, and facilitating a thinner vapor chamber design.

Another objective of this disclosure is to provide a vapor chamber manufacturing method and product thereof, in which a supporting structure is configured by selective laser sintering 3D printing, so as to provide sufficient structural support to the internal space of the vapor chamber, thereby preventing deformation or damage during manufacturing or use and maintaining the structural integrity and stability of the vapor chamber.

In order to achieve the above objectives, this disclosure provides a vapor chamber manufacturing process, which includes the steps of: a) providing a stainless steel shell having a cavity; b) roughening an inner wall surface of the stainless steel shell to form a roughened surface; c) forming a capillary structure on the roughened surface; d) forming a supporting structure by selective laser sintering 3D printing and positioning the supporting structure in the cavity; e) filling a working fluid; f) providing a sealed chamber and placing the stainless steel shell therein; g) evacuating the sealed chamber; and h) sealing the stainless steel shell.

In one embodiment of this disclosure, the stainless-steel shell includes a bottom plate, a side frame, and a cover plate. In step b), the roughening is performed by laser on the wall surface of the bottom plate and the cover plate facing the cavity.

In one embodiment of this disclosure, in step c), the capillary structure is configured by selective laser sintering 3D printing g of stainless-steel powder, and the capillary structure has a thickness of not less than 0.01 mm and not greater than 0.1 mm.

In one embodiment of this disclosure, the supporting structure includes a plate and a plurality of protrusions, and the supporting structure is configured such that 25 to 30 protrusions per square centimeter are arranged on two sides of the plate opposite to each other.

In one embodiment of this disclosure, in step e), the working fluid is first filled into the supporting structure, and then the supporting structure with the working fluid is placed into the cavity.

In one embodiment of this disclosure, in step f), the stainless-steel shell is positioned and secured by a jig.

In one embodiment of this disclosure, in step g), the sealed chamber is vacuumed at a temperature below the boiling point of the working fluid.

In one embodiment of this disclosure, in step h), the stainless-steel shell is sealed by laser welding.

In order to achieve the above objectives, this disclosure provides a vapor chamber including a stainless-steel shell, a capillary structure, a supporting structure, and working fluid. The stainless-steel shell has a cavity and includes a roughened surface facing the cavity. The capillary structure is disposed on the roughened surface. The supporting structure is positioned in the cavity. The supporting structure includes a plate formed by selective laser sintering 3D printing and a plurality of protrusions stacked and printed on the plate, wherein the protrusions are arranged spacedly and are located on two sides of the plate opposite to each other. The working fluid is filled in the cavity.

In one embodiment of this disclosure, the supporting structure includes a plate and a plurality of protrusions, each of the protrusions being a hollow cone, and the protrusions located on one side of the plate are connected to adjacent protrusions on another side of the plate.

In comparison with the prior art, the vapor chamber manufacturing process of this disclosure involves roughening the inner wall surface of a stainless-steel shell and forming a capillary structure on the roughened surface. Additionally, a supporting structure is formed by selective laser sintering 3D printing. Thereafter, the semi-finished vapor chamber is placed in a sealed chamber, where vacuuming and laser welding are performed to complete the vapor chamber. Since the vapor chamber manufacturing method of this disclosure does not require a filling tube, it reduces manufacturing complexity and cost. Additionally, eliminating the filling tube also allows for a thinner vapor chamber design by avoiding the need for additional space. Moreover, the supporting structure is formed by selective laser sintering 3D printing, which further simplifies the design and manufacturing process, reduces manufacturing complexity and cost, and contributes to the overall compactness and thin-profile design of the vapor chamber.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a flow chart illustrating the steps of the vapor chamber manufacturing process of this disclosure.

FIG. 2 is an exploded perspective view of the vapor chamber of this disclosure.

FIG. 3 is a perspective schematic view illustrating the supporting structure of this disclosure.

FIG. 4 is a schematic view illustrating the working fluid filling into the supporting structure of this disclosure.

FIG. 5 is a schematic view illustrating the clamping of a jig according to this disclosure.

FIG. 6 is a schematic view illustrating the vacuuming process of the vapor chamber manufacturing process according to this disclosure.

FIG. 7 is a schematic view illustrating the welding process of the vapor chamber manufacturing process according to this disclosure.

FIG. 8 is a perspective schematic view illustrating the vapor chamber according to this disclosure.

FIG. 9 is a sectional view of the vapor chamber according to this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

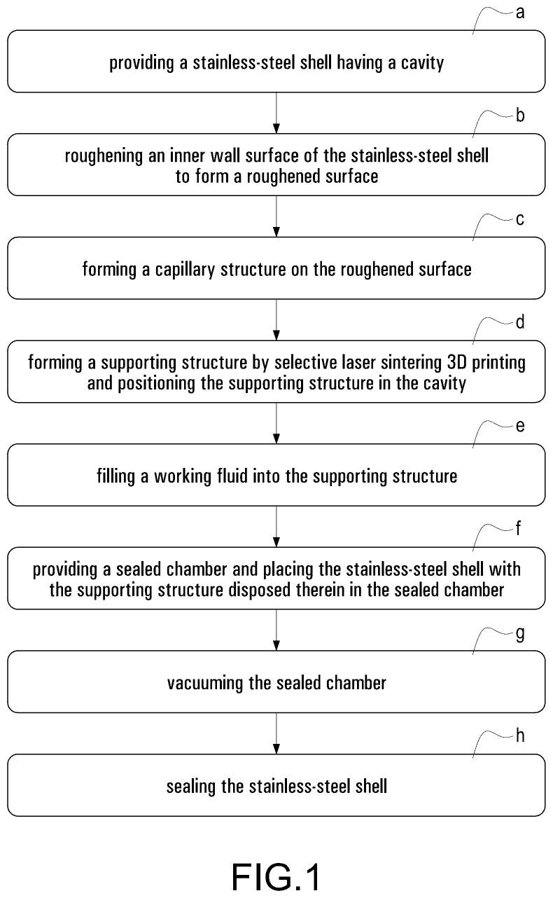

Referring to FIG. 1, it is a flow chart illustrating the steps of the vapor chamber manufacturing process according to this disclosure. This disclosure provides a vapor chamber manufacturing process without a filling tube (degassing tube), in which a filling tube is not required during the processes of filling the working fluid, degassing, or vacuuming. Furthermore, this disclosure also provides a vapor chamber manufactured according to the manufacturing process shown in FIG. 1.

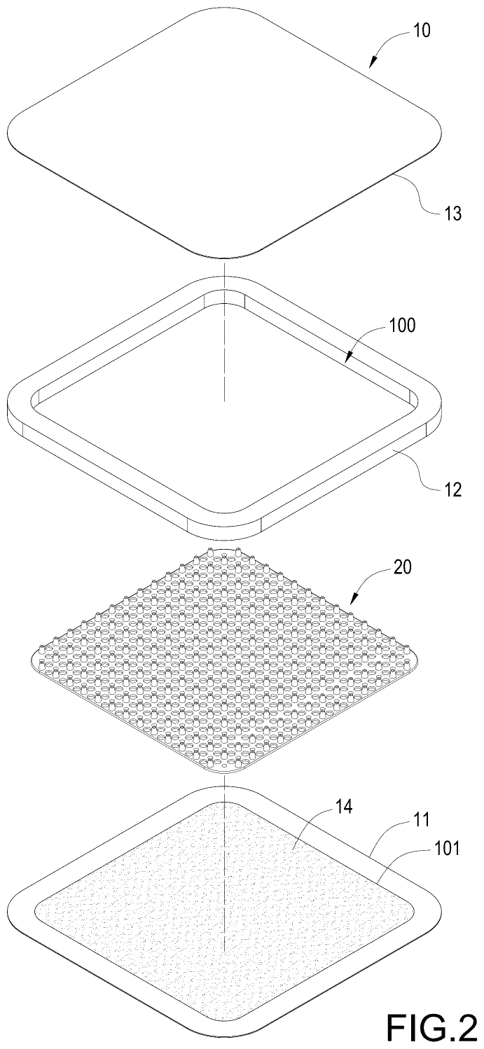

Referring to FIG. 2, which is an exploded perspective view of the vapor chamber according to this disclosure and is described in conjunction with the vapor chamber manufacturing process shown in FIG. 1, the vapor chamber manufacturing process of this disclosure includes step a): providing a stainless-steel shell 10 having a cavity 100. In step b), roughening the inner wall surface of the stainless-steel shell 10 to form a roughened surface.

In this embodiment, the stainless-steel shell 10 includes a bottom plate 11, a side frame 12, and a cover plate 13. The side frame 12 is disposed between the bottom plate 11 and the cover plate 13 to configure the cavity 100 therebetween. Furthermore, as described in step b), the wall surface of the bottom plate 11 and the cover plate 13 facing the cavity 100 is roughened by laser processing. As further described in step c), a capillary structure 14 is formed on the roughened surface. Specifically, the capillary structure 14 is formed by selective laser sintering 3D printing of stainless-steel powder, and the capillary structure 14 has a thickness of not less than 0.01 mm and not greater than 0.1 mm.

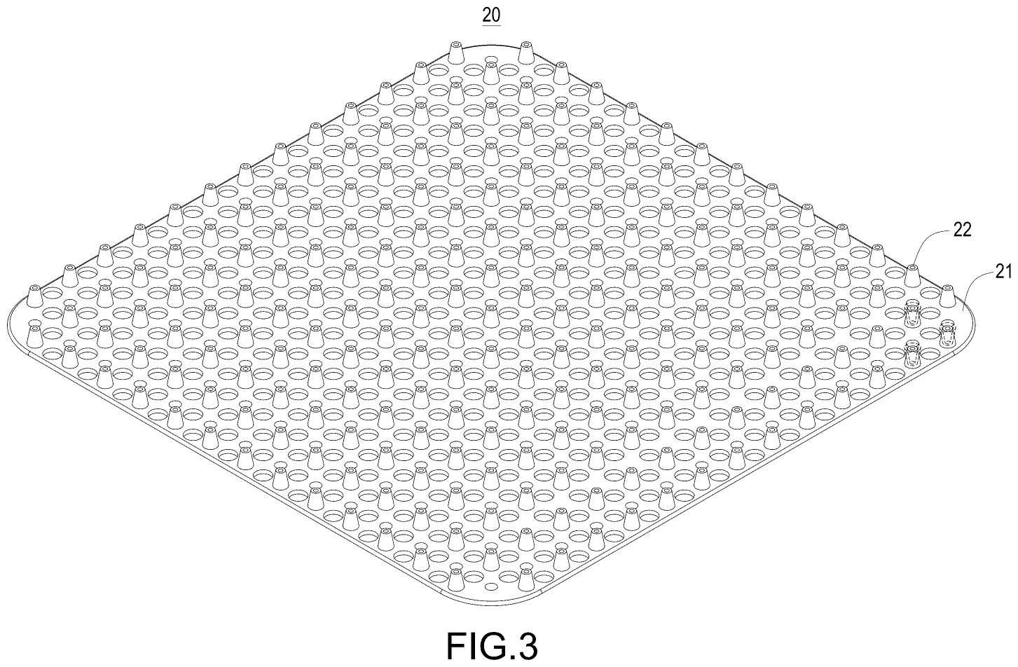

Furthermore, in accordance with step d), this disclosure forms a supporting structure 20 by selective laser sintering 3D printing and positions the supporting structure 20 in the cavity 100. Please also refer to FIG. 3, which is a perspective schematic view illustrating the supporting structure of this disclosure. In this embodiment, the supporting structure 20 includes a plate 21 and a plurality of protrusions 22. The supporting structure 20 is configured such that 25 to 30 protrusions 22 are arranged per square centimeter on two sides of the plate 21 opposite to each other. Specifically, each protrusion 22 is a hollow cone. Additionally, the protrusions 22 on one side of the plate 21 are connected to adjacent protrusions 22 on the opposite side thereof. It should be noted that through holes are further disposed between adjacent protrusions 22 to facilitate gas flow.

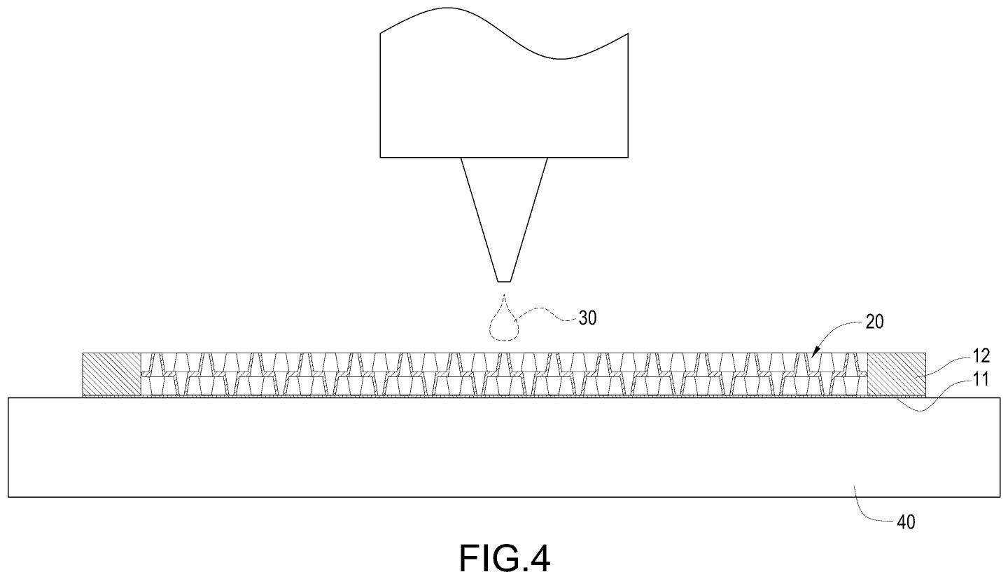

Please also refer to FIG. 4, which is a schematic view illustrating the working fluid filling into the supporting structure of this disclosure and is described in conjunction with the vapor chamber manufacturing process shown in FIG. 1. The vapor chamber manufacturing process of this disclosure further includes step e), filling a working fluid 30 into the supporting structure 20. In this embodiment, the working fluid 30 is first filled into the supporting structure 20, and then the supporting structure 20 with the working fluid 30 is placed into the cavity 100. In some embodiments, the working fluid 30 may alternatively be filled into the cavity 100 after the supporting structure 20 has been placed in the stainless-steel shell 10. It should be noted that the bottom plate 11 may first be laid flat on a processing platform 40, and then the side frame 12 is placed on the bottom plate 11 to form the cavity 100, thereby facilitating the subsequent placement of the supporting structure 20.

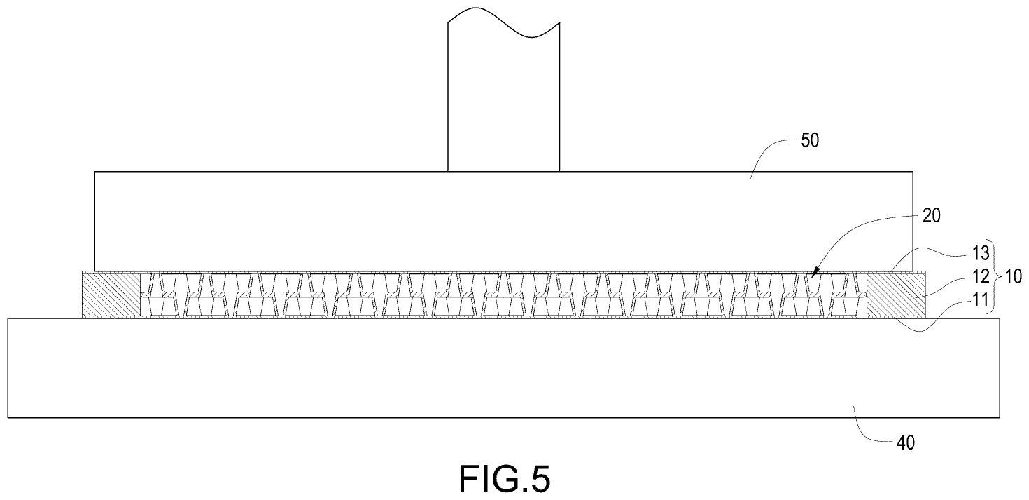

Please refer to FIG. 5, which is a schematic view illustrating the clamping of a jig according to this disclosure. The stainless-steel shell 10 includes a bottom plate 11, a side frame 12, and a cover plate 13. After the working fluid 30 is filled in the cavity 100, the cover plate 13 is placed over the side frame 12 to seal the cavity 100. In some embodiments, the stainless-steel shell 10 is positioned and clamped in place by a jig 50.

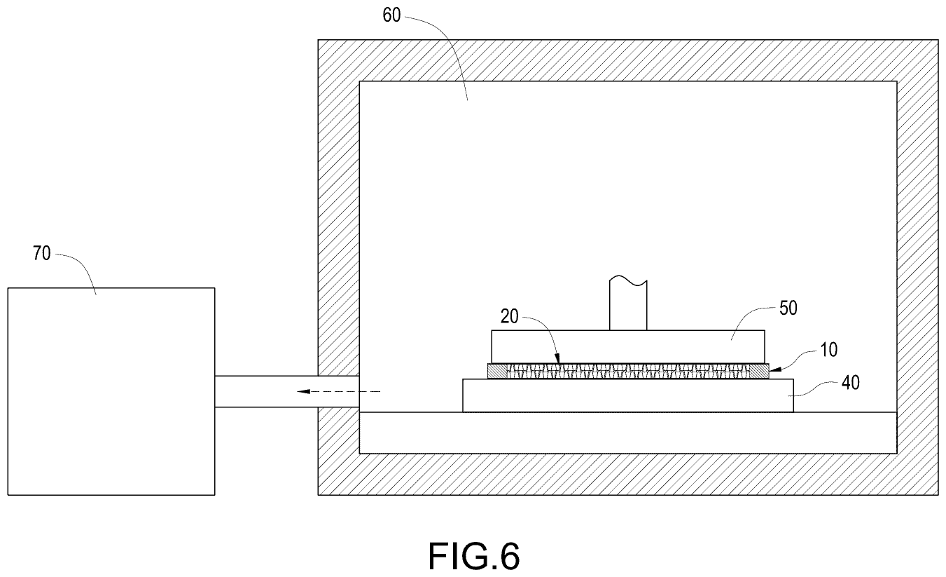

Please refer to FIG. 6, which is a schematic view illustrating the vacuuming process of the vapor chamber manufacturing process of this disclosure and is described in conjunction with the process shown in FIG. 1. The vapor chamber manufacturing process of this disclosure further includes step f), in which a sealed chamber 60 is provided, and the stainless-steel shell 10 with the supporting structure 20 disposed therein is placed into the sealed chamber 60. The stainless-steel shell 10 is placed on the processing platform 40 and is clamped by the jig 50. Additionally, the vapor chamber manufacturing process includes step g), in which a vacuum device 70 is used to evacuate the sealed chamber 60, such that the sealed chamber 60 and the cavity 100 of the stainless-steel shell 10 are brought into a vacuum state.

It should be noted that the vacuum device 70 may include a vacuum pump configured to evacuate the sealed chamber 60. Moreover, during the vacuuming operation of step g), the sealed chamber 60 is maintained at a temperature lower than the boiling point of the working fluid 30.

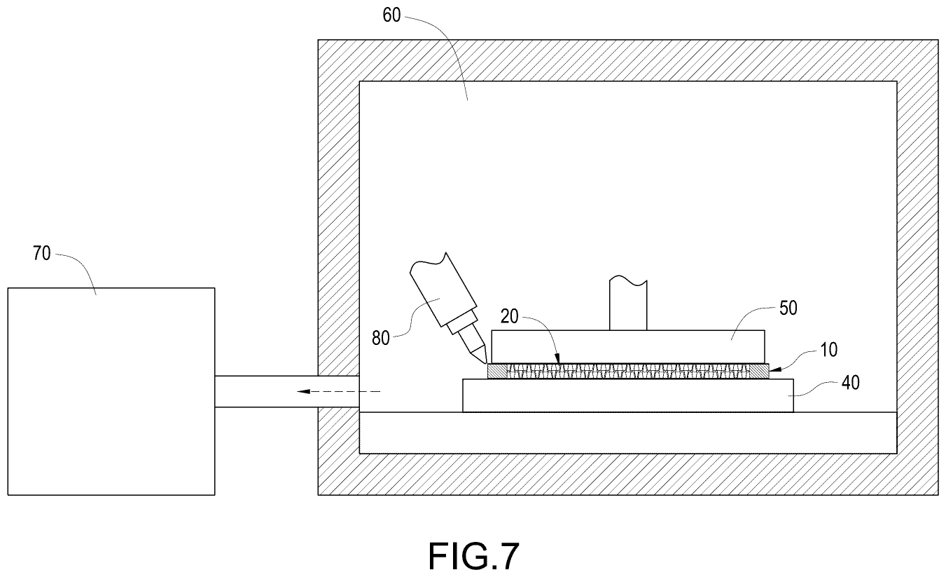

Please refer to FIG. 7, which is a schematic view illustrating the welding process of the vapor chamber manufacturing process of this disclosure and is described in conjunction with the process shown in FIG. 1. The vapor chamber manufacturing process of this disclosure further includes step h), in which the stainless-steel shell 10 is sealed. In this disclosure, laser welding is performed on the surface of the stainless-steel shell 10 to position the supporting structure 20. Furthermore, this disclosure performs laser welding along the periphery of the stainless-steel shell 10 to combine the bottom plate 11, the side frame 12, and the cover plate 13, thereby maintaining the vacuum and sealing integrity of the cavity 100 and completing the vapor chamber 1.

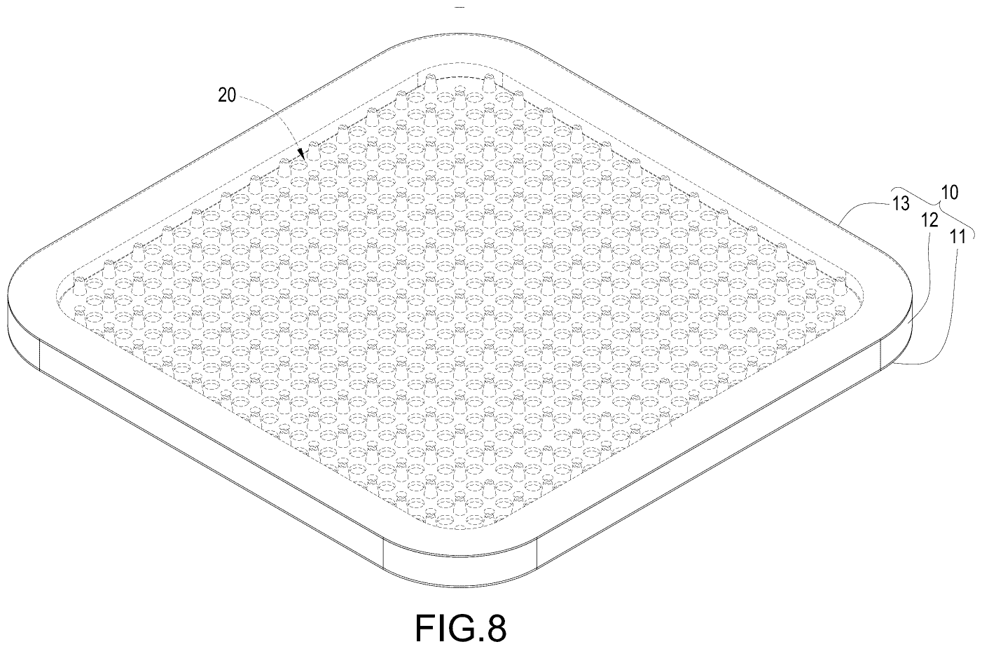

Please refer to FIG. 8, which is a perspective schematic view of the vapor chamber of this disclosure. The vapor chamber 1 is manufactured according to the aforementioned vapor chamber manufacturing process. Since the vapor chamber 1 is fabricated without using a filling tube (degassing tube) during the process, no filling tube or post-processing marks are visible on the exterior of the finished product.

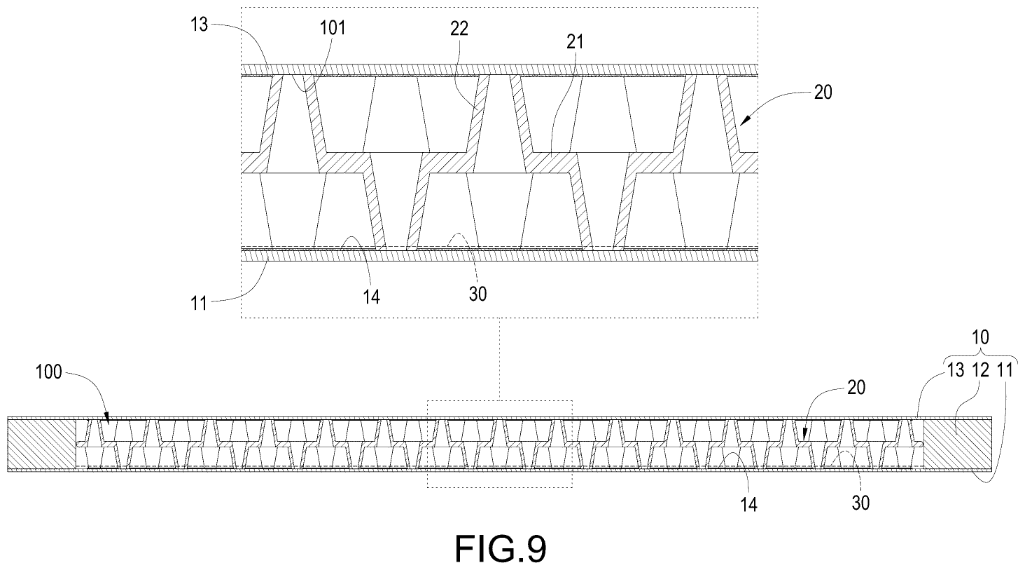

Please refer also to FIG. 9, which is a sectional view of the vapor chamber of this disclosure. The vapor chamber 1 includes a stainless-steel shell 10, a capillary structure 14, a supporting structure 20, and a working fluid 30. The stainless-steel shell 10 has a cavity 100 and includes a roughened surface 101 facing the cavity 100.

Furthermore, the supporting structure 20 is positioned in the cavity 100. The supporting structure 20 includes a plate 21 formed by selective laser sintering 3D printing and a plurality of protrusions 22 stacked and printed on the plate 21. The protrusions 22 are arranged spacedly and disposed on two sides of the plate 21 opposite to each other. Additionally, the working fluid 30 is filled in the cavity 100.

Specifically, the stainless-steel shell 10 includes a bottom plate 11, a side frame 12, and a cover plate 13. The supporting structure 20 includes a plate 21 and a plurality of protrusions 22. Each of the protrusions 22 is a hollow cone, and the protrusions 22 on one side of the plate 21 are connected to adjacent protrusions 22 on the opposite side. The protrusions 22 on one side of the supporting structure 20 abut against the bottom plate 11, while the protrusions 22 on the other side abut against the cover plate 13.

Accordingly, the vapor chamber 1 of this disclosure is constructed without a filling tube; thus, the complexity and cost of production may be reduced, and no additional space is occupied to facilitate the thin design of the vapor chamber 1. Additionally, the internal supporting structure is formed by selective laser sintering 3D printing, which simplifies the structural design and manufacturing process, further reducing manufacturing complexity and cost.

While this disclosure has been described by means of specific embodiments, numerous modifications and variations may be made thereto by those skilled in the art without departing from the scope and spirit of this disclosure set forth in the claims.

What is claimed is:

1. A vapor chamber manufacturing process, comprising:
a) providing a stainless-steel shell having a cavity;
b) roughening an inner wall surface of the stainless-steel shell to form a roughened surface;
c) forming a capillary structure on the roughened surface;
d) forming a supporting structure by selective laser sintering 3D printing and positioning the supporting structure in the cavity;
e) filling a working fluid into the supporting structure;
f) providing a sealed chamber and placing the stainless-steel shell with the supporting structure disposed therein in the sealed chamber;
g) vacuuming the sealed chamber; and
h) sealing the stainless-steel shell.

2. The vapor chamber manufacturing process according to claim 1, wherein the stainless-steel shell comprises a bottom plate, a side frame, and a cover plate, and in step b), the roughening is performed by laser on a wall surface of the bottom plate and the cover plate facing the cavity.

3. The vapor chamber manufacturing process according to claim 1, wherein in step c), the capillary structure is configured by selective laser sintering 3D printing of stainless-steel powder, and the capillary structure has a thickness of not less than 0.01 mm and not greater than 0.1 mm.

4. The vapor chamber manufacturing process according to claim 1, wherein the supporting structure comprises a plate and a plurality of protrusions, and the supporting structure is configured such that 25 to 30 protrusions per square centimeter are arranged on two sides of the plate opposite to each other.

5. The vapor chamber manufacturing process according to claim 1, wherein in step e), the working fluid is first filled into the supporting structure, and then the supporting structure with the working fluid is placed into the cavity.

6. The vapor chamber manufacturing process according to claim 1, wherein in step f), the stainless-steel shell is positioned and secured by a jig.

7. The vapor chamber manufacturing process according to claim 1, wherein in step g), the sealed chamber is vacuumed at a temperature below a boiling point of the working fluid.

8. The vapor chamber manufacturing process according to claim 1, wherein in step h), the stainless-steel shell is sealed by laser welding.

9. A vapor chamber, comprising:
a stainless-steel shell, having a cavity and comprising a roughened surface facing the cavity;
a capillary structure, disposed on the roughened surface;
a supporting structure, positioned in the cavity, the supporting structure comprising a plate formed by selective laser sintering 3D printing and a plurality of protrusions stacked and printed on the plate, wherein the protrusions are arranged spacedly and are located on two sides of the plate opposite to each other; and
a working fluid, filled in the cavity.

10. The vapor chamber according to claim 9, wherein the supporting structure comprises a plate and a plurality of protrusions, each of the protrusions being a hollow cone, and the protrusions located on one side of the plate are connected to adjacent protrusions on another side of the plate.

11. The vapor chamber according to claim 9, wherein the stainless-steel shell comprises a bottom plate, a side frame, and a cover plate, and the roughened surface on the bottom plate and the cover plate is formed by laser roughening.

12. The vapor chamber according to claim 9, wherein the capillary structure is formed by selective laser sintering 3D printing of stainless-steel powder, and a thickness of the capillary structure is not less than 0.01 mm and not greater than 0.1 mm.

13. The vapor chamber according to claim 9, wherein the supporting structure comprises a plate and a plurality of protrusions, and the supporting structure is configured such that 25 to 30 protrusions per square centimeter are arranged on two sides of the plate opposite to each other.

14. The vapor chamber according to claim 9, wherein the working fluid is first filled in the supporting structure, and then the supporting structure with the working fluid is placed into the cavity.
